(19) United States
(12) Patent Application Publication
(10) Pub. No.: US 2015/0004818 A1
(43) Pub. Date: Jan. 1, 2015

(54) CHIP CARD EJECTING MECHANISM

(71) Applicant: Chiun Mai Communication Systems, Inc., New Taipei (TW)

(72) Inventors: PO-HAN HUANG, New Taipei (TW); YU-CHIEH CHENG, New Taipei (TW); MIN-SHENG WANG, New Taipei (TW); MONG-HAU TSAI, New Taipei (TW)

(21) Appl. No.: 14/314,633

(22) Filed: Jun. 25, 2014

(30) Foreign Application Priority Data
Jun. 27, 2013 (TW) 102123076

(51) Int. Cl. H01R 12/71

(52) U.S. Cl. CPC H01R 12/71
USPC 439/135

(57) ABSTRACT

A chip card ejecting mechanism includes a main body, a tray assembled in the main body and configured to receive a chip card, and a door. The door includes a rotating end rotatably mounted on the main body and a push pole protruding from the rotating end. A resisting portion is located on an end of the push pole away from the rotating end.

When the door is opened and the rotating end is rotated relative to the main body, the resisting portion resists against the chip card and drives the chip card to move out from the main body.

### FIELD

The subject matter herein generally relates to a chip card ejecting mechanism.

### BACKGROUND

Portable electronic devices, such as mobile phones, commonly include an operable ejecting mechanism for ejecting a chip card, such as a subscriber identity module (SIM) card, from a casing.

### BRIEF DESCRIPTION OF THE DRAWINGS

Implementations of the present technology will now be described, by way of example only, with reference to the attached figures.

FIG. 1 is an exploded, isometric view of an embodiment of a chip card ejecting mechanism.

FIG. 2 is an isometric view of a circuit board of the chip card ejecting mechanism of FIG. 1.

FIG. 3 is a partially assembled view of the chip card ejecting mechanism of FIG. 1.

FIG. 4 is similar to FIG. 3, but shown from another angle.

FIG. 5 is an assembled view of the chip card ejecting mechanism of FIG. 3.

FIG. 6 is an isometric view of the chip card ejecting mechanism of FIG. 5, showing a door in a closed configuration.

FIG. 7 is similar to FIG. 6, but showing the door in an open configuration.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

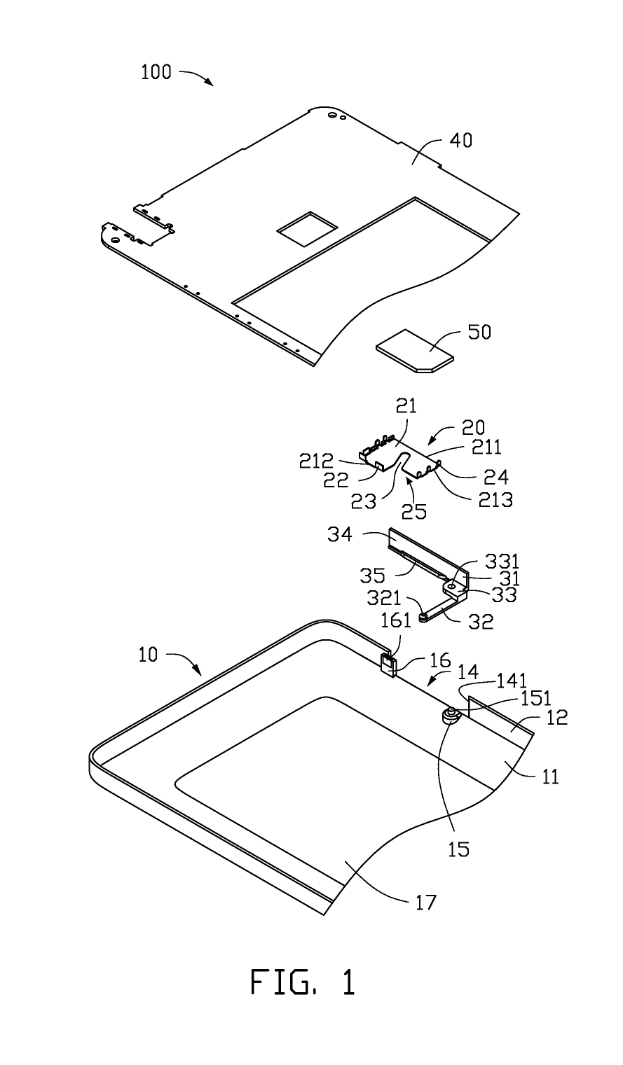

FIG. 1 illustrates a chip card ejecting mechanism 100 for removably receiving a chip card 50 in an electronic device (not shown), such as a mobile phone. The chip card 50 can be a subscriber identity module (SIM) card, a memory card, or a multimedia card (MMC).

The chip card ejecting mechanism 100 includes a main body 10, a tray 20 assembled in the main body 10 and configured to receive the chip card 50, and a door 30. The door 30 includes a rotating end 31 rotatably mounted on the main body 10 and a push pole 32 protruding from the rotating end 31. A resisting portion 321 is located on an end of the push pole 32 away from the rotating end 31.

The main body 10 can be a housing of the electronic device, for example. The main body 10 includes a bottom surface 11 and a peripheral wall 12. The peripheral wall 12 extends substantially perpendicularly from a periphery of the bottom surface 11. The peripheral wall 12 defines an entrance 14. The entrance 14 includes two opposite sidewalls 141. In this embodiment, the entrance 14 is substantially rectangular. The door 30 can cover the entrance 14 and the chip card 50 can be received in and removed from the tray 20 through the entrance 14.

The main body 10 further includes a projection 15 and a fixing portion 16.

The projection 15 projects from the bottom surface 11 adjacent to one sidewall 141 of the entrance 14. The projection 15 includes a post 151 protruding from a surface of the projection 15 away from the bottom surface 11. The fixing portion 16 is perpendicularly mounted on the bottom surface 11 adjacent to another sidewall 141 of the entrance 14. A latching portion 161 is positioned on the fixing portion 16 and is configured to lock the door 30 when the door 30 covers the entrance 14. In this embodiment, the locking portion 161 is a magnetic element, such as a magnet.

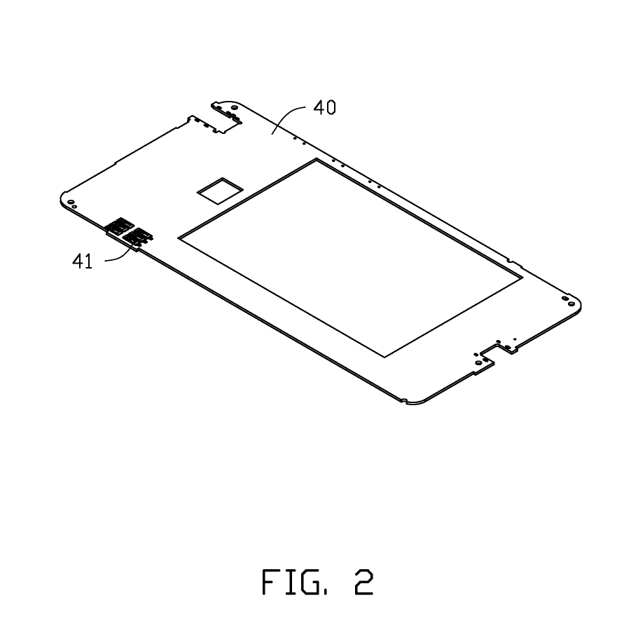

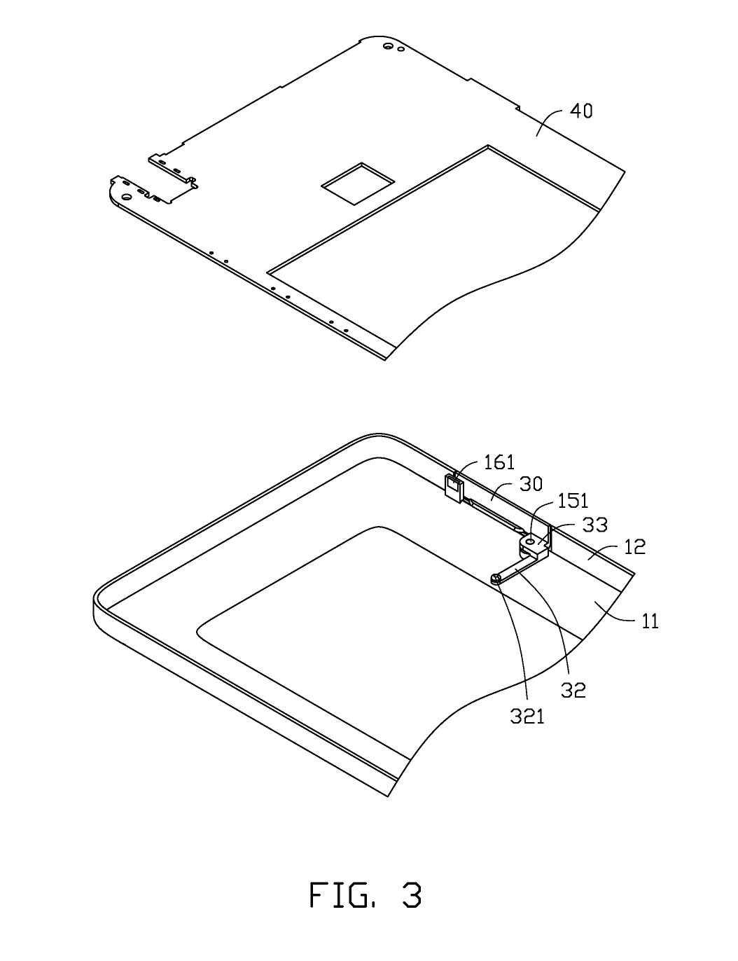

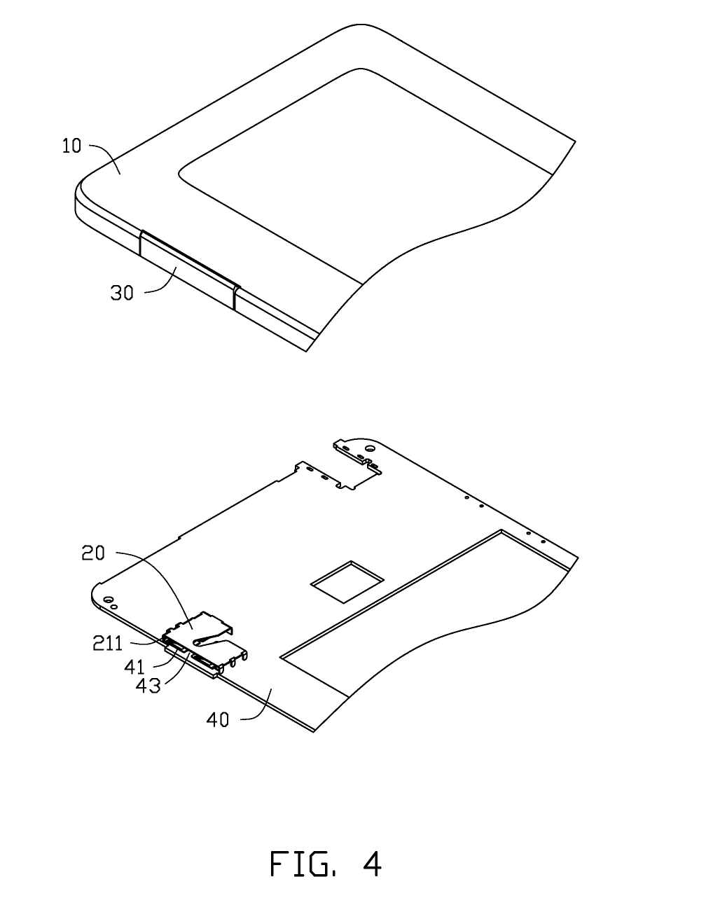

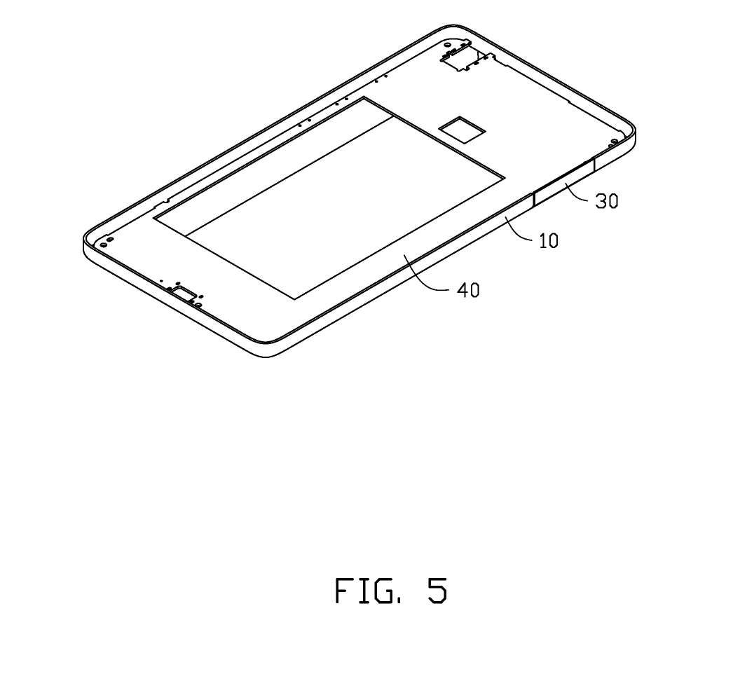

FIGS. 2-5 illustrate a circuit board 40 of the chip card ejecting mechanism 100. The bottom surface 11 and the peripheral wall 12 cooperatively define a mounting space 17 for receiving the circuit board 40. The circuit board 40 includes a plurality of connectors 41 configured for electronically connecting the chip card 50.

The tray 20 is secured above the connectors 41 so that the tray 20 and the circuit board 40 cooperatively define a receiving space 43 aligned with the entrance 14 to receive the chip card 50. The tray 20 includes a base 21. The base 21 includes a first end 211, a second end 212 opposite and parallel to the first end 211, and a limiting plate 22 extending perpendicularly from the second end 212. In this embodiment, the first side 211 is aligned with the entrance 14 and the receiving space 43. The first side 211 is further mounted between the projection 15 and the fixing portion 16. A guiding groove 23 is defined in the second end 212 adjacent to the limiting plate 22. When the rotating end 31 is rotated relative to the main body 10, the resisting portion 321 slides in the guiding groove 23 and resists against the chip card 50.

The base 21 further includes two third ends 213 connected substantially perpendicularly to the first end 211 and the second end 212. A plurality of connecting portions 24 are perpendicularly positioned on the two third ends 213. The tray 20 is secured above the circuit board 40 by the ends of the connecting portions 24 away from the base 21, which are mounted on the circuit board 40. The circuit board 40, the base 21, and the plurality of the connecting portions 24 define the receiving space 43. In this embodiment, a corner-edge piece of the base 21 defines a cutout 25. The cutout 25 communicates with the guiding groove 23 and is configured to expose one portion of the chip card 50 from the tray 20.

The door 30 further includes a shaft portion 33, a free end 34, and a flange 35. The shaft portion 33 protrudes from a side of the rotating end 31 toward the entrance 14. The push pole 32 extends from an end of the shaft portion 33 away from the door 30. The shaft portion 33 defines a shaft hole 331. The door 30 rotates relative to the main body 10 by the post 151 rotatably engaging in the shaft hole 331. The free end 34 is opposite to the rotating end 31 and configured to rotate the door 30 relative to the main body 10. In this embodiment, the door 30 is made of magnetically attractive material, such as a metal. Thus, when the door 30 covers the entrance 14, the free end 34 can be magnetically attracted to the fixing portion 16. The flange 35 protrudes between the rotating end 31 and the free end 34 and resists against the chip card 50 for securing the chip card 50 so the chip card 50 will not loosen in the receiving space 43.

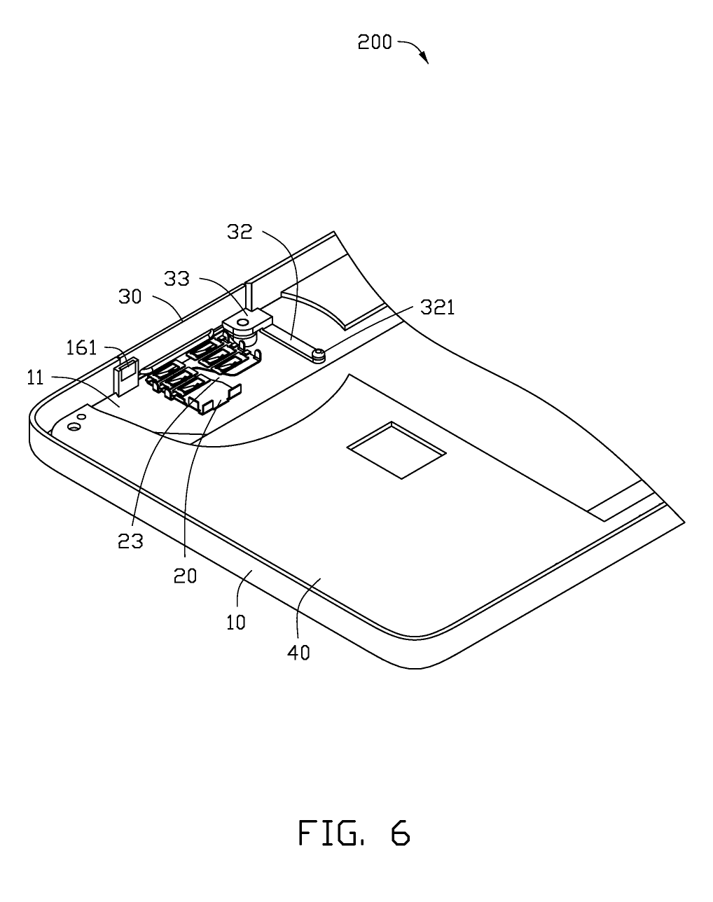

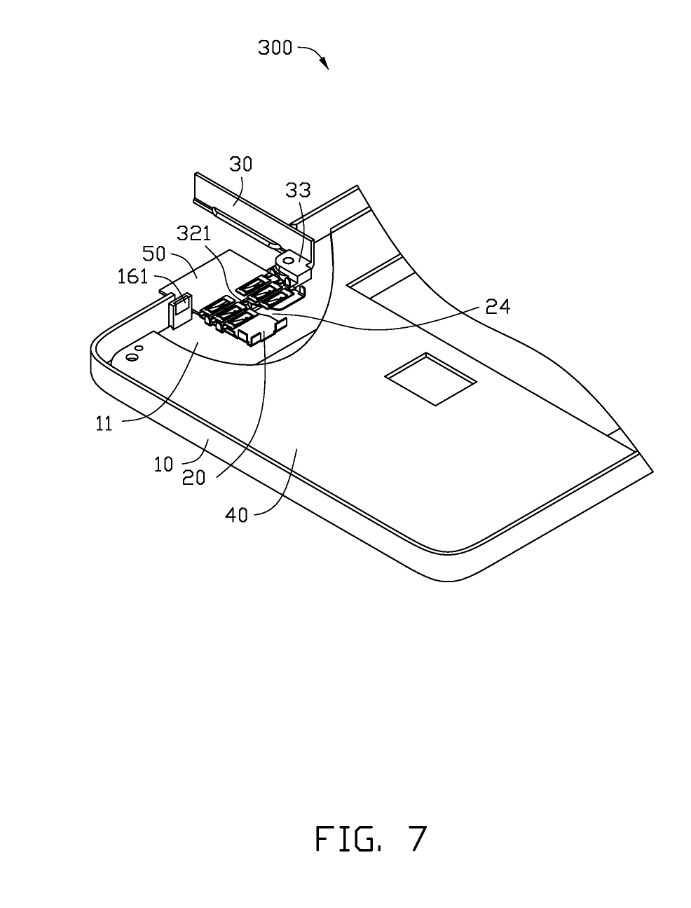

FIGS. 6 and 7 illustrate when an external force opens the door 30, the rotating end 31 is rotated relative to the main body 10 along with the door 30, the resisting portion 321 moves and resists against the chip card 50 and drives the chip card 50 at least partially out from the main body 10.

FIG. 6 illustrates the door 30 in a closed configuration 200. When the chip card 50 is received in the receiving space 43, the chip card 50 can be electronically connected to the connectors 41 of the circuit board 40. The latching portion 161 of the fixing portion 16 magnetically attracts the free end 34 and the door 30 covers the entrance 14. A periphery of the chip card 50 is resisted by the limiting plate 22 and the flange 35. A portion of the chip card 50 adjacent to the second end 212 is exposed from the cutout 25.

FIG. 7 illustrates the door 30 in an open configuration 300 in which the rotating end 31 rotates relative to the main body 10. The resisting portion 321 rotates around the post 151 of the projection 15 and slides in the gilding groove 23 to resist against the chip card 50. The chip card 50 is ejected from the receiving space 43 and is exposed from the entrance 14 for easy removal.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A chip card ejecting mechanism for ejecting a chip card, the chip card ejecting mechanism comprising:
a main body;
a tray assembled in the main body and configured to receive the chip card; and
a door comprising:
a rotating end rotatably mounted on the main body;
a push pole protruding from the rotating end; and
a resisting portion located on an end of the push pole away from the rotating end;
wherein when the door is opened and the rotating end rotates relative to the main body, the resisting portion resists against the chip card and drives the chip card to move out from the main body.

2. The chip card ejecting mechanism of claim 1, wherein the main body comprises a bottom surface and a peripheral wall extending perpendicularly from a periphery of the bottom surface, the peripheral wall defines an entrance forming two opposite sidewalls, the door covers the entrance, and the chip card is received in and removed out from the tray through the entrance.

3. The chip card ejecting mechanism of claim 2, wherein the door further comprise a shaft portion protruding from a side of the rotating end towards the entrance, the push pole is extended from an end of the shaft portion away from the door, the shaft portion defines a shaft hole, the main body further comprises a projection projecting from the bottom surface adjacent to one sidewall of the entrance, the projection comprises a post protruding from a surface of the projection away from the bottom surface, and the door rotates relative to the main body by the post rotatably engaging in the shaft hole.

4. The chip card ejecting mechanism of claim 2, wherein the door further comprises a free end opposite to the rotating end and configured to rotate the door relative to the main body.

5. The chip card ejecting mechanism of claim 2, wherein the main body further comprises a fixing portion perpendicularly mounted on the bottom surface adjacent to another sidewall of the entrance, a latching portion is positioned on the fixing portion and is configured to lock the free end when the door covers the entrance.

6. The chip card ejecting mechanism of claim 5, wherein the door is made of a magnetically attractive material and the locking portion is a magnetic element.

7. The chip card ejecting mechanism of claim 4, further comprising a circuit board, wherein the bottom surface and the peripheral wall cooperatively define a mounting space for receiving the circuit board, the circuit board comprises a plurality of connectors configured for electronically connecting the chip card, and the tray is secured above the connectors, the tray and the circuit board cooperatively define a receiving space aligned with the entrance to receive the chip card, the tray further comprises a flange protruding between the rotating end and the free end to resist against the chip card when the door covers the entrance.

8. The chip card ejecting mechanism of claim 3, wherein the tray comprises a base; the base comprises a first end, a second end opposite to and parallel to the first end, and a limiting plate perpendicularly extending from the second end; the first side is aligned with the entrance and the receiving space, and is further mounted between the projection and the fixing portion; the base defines a guiding groove on the second end adjacent to the limiting plate and, when the rotating end is rotated relative to the main body, the resisting portion slides in the guiding groove and resists against the chip card.

9. The chip card ejecting mechanism of claim 8, wherein the base further comprises two third ends substantially perpendicularly connected to the first end and the second end, a plurality of connecting portions perpendicularly positioned on the two third ends, the tray is secured above the circuit board by ends of the connecting portions away from the base being mounted on the circuit board, and the receiving space is formed by the circuit board, the base, and the plurality of the connecting portions.

10. The chip card ejecting mechanism of claim 8, wherein a corner-edge piece of the base defines a cutout, the cutout communicates with the guiding groove and is configured to expose one portion of the chip card from the tray.

11. A chip card ejecting mechanism for removing a chip card, the chip card ejecting mechanism comprising:
a main body;
a tray assembled in the main body and configured to receive the chip card; and
a door comprising:
a rotating end;
a push pole protruding from the rotating end; and
a resisting portion located on an end of the push pole away from the rotating end;
wherein the door is transitionable between: (i) a closed configuration in which the main body is covered by the door and the chip card is received in the tray; and (ii) an open configuration in which the door rotates relative to the main body to drive the resisting portion to resist against the chip card for removing the chip card out from the main body.

12. The chip card ejecting mechanism of claim 11, wherein the main body comprises a bottom surface and a peripheral wall extending perpendicularly from a periphery of the bottom surface, the peripheral wall defines an entrance forming two opposite sidewalls, the door covers the entrance, and the chip card is received in and removed out from the tray through the entrance.

13. The chip card ejecting mechanism of claim 12, wherein the door further comprise a shaft portion protruding from a side of the rotating end towards the entrance, the push pole is extended from an end of the shaft portion away from the door, the shaft portion defines a shaft hole, the main body further comprises a projection projecting from the bottom surface adjacent to one sidewall of the entrance, the projection comprises a post protruding from a surface of the projection away from the bottom surface, and the post rotatably engages in the shaft hole.

14. The chip card ejecting mechanism of claim 12, wherein the door further comprises a free end opposite to the rotating end and configured to rotate the door relative to the main body.

15. The chip card ejecting mechanism of claim 12, wherein the main body further comprises a fixing portion perpendicularly mounted on the bottom surface adjacent to another sidewall of the entrance, a latching portion is positioned on the fixing portion and is configured to lock the free end when the door covers the entrance.

16. The chip card ejecting mechanism of claim 14, further comprises a circuit board, the bottom surface and the peripheral wall cooperatively define a mounting space for receiving the circuit board, the circuit board comprises a plurality of connectors configured for electronically connecting the chip card, the tray is secured above the connectors, and the tray and the circuit board cooperatively define a receiving space aligned with the entrance to receive the chip card, the tray further comprises a flange protruding between the rotating end and the free end to resist against the chip card when the door covers the entrance.

17. The chip card ejecting mechanism of claim 13, wherein the tray comprises a base; the base comprises a first end, a second end opposite to and parallel to the first end, and a limiting plate perpendicularly extending from the second end; the first side is aligned with the entrance and the receiving space, and is further mounted between the projection and the fixing portion; and the base defines a guiding groove on the second end adjacent to the limiting plate and, when the rotating end is rotated relative to the main body, the resisting portion slides in the guiding groove and resists against the chip card.

18. The chip card ejecting mechanism of claim 17, wherein the base further comprises two third ends substantially perpendicularly connected to the first end and the second end, a plurality of connecting portions perpendicularly positioned on the two third ends, the tray is secured above the circuit board by ends of the connecting portions away from the base being mounted on the circuit board, and the receiving space is formed by the circuit board, the base, and the plurality of the connecting portions.

19. The chip card ejecting mechanism of claim 17, wherein a corner-edge piece of the base is cut off to define a cutout, the cutout communicates with the guiding groove and is configured to expose one portion of the chip card from the tray.

20. A chip card ejecting mechanism configured to eject a chip card, the chip card ejecting mechanism comprising:
a main body;
a tray coupled to the main body and configured to receive the chip card;
a door comprising:
a rotating end rotatably mounted on the main body;
a push pole protruding from the rotating end;
a resisting portion located on an end of the push pole away from a portion protruding from the rotating end;
wherein the rotating end rotates relative to the main body while the door is being opened and the resisting portion provides a motive force to eject the chip card out from the main body.
